(19) United States
(12) Patent Application Publication
(10) Pub. No.: US 2011/0161825 A1
(43) Pub. Date: Jun. 30, 2011

(54) SYSTEMS AND METHODS FOR TESTING MULTIPLE PAGE VERSIONS ACROSS MULTIPLE APPLICATIONS

(76) Inventors: Chris TIERNEY, San Francisco, CA (US); William W. Graham, JR., San Francisco, CA (US)

(21) Appl. No.: 12/651,328

(22) Filed: Dec. 31, 2009

(51) Int. Cl. G06F 15/177

(52) U.S. Cl. 715/736

(57) ABSTRACT

An architectural stack includes a multivariate testing system between the web server and the HTTP proxy cache. The multivariate testing system receives a user request to access a web page from the web server, applies a rule to the user request to assign the user to a test group, each test group associated with a different page version for testing, and delivers a web page or web site version to the user based on the user's assigned test group. The user's interactions with the delivered web page and subsequent behavior are then tracked or recorded and aggregated with all of the other users and other test groups. The aggregated data can then be analyzed to determine a test result.

### BACKGROUND

1. Field

The subject invention relates to systems and methods for testing multiple page versions across multiple applications and systems and methods for allocating users to test groups across multiple site applications.

2. Related Art

Users of the Internet visit various websites for a variety of reasons. Users, however, prefer certain websites over other websites based in part on the design of the website, the layout of the website, the content provided by the website or the content delivery method.

Some websites perform multivariate testing to test these aspects of their web pages. In multivariate testing, different versions of the same web page are delivered to different users to determine whether users prefer a certain version of that web page. The users' interactions with the different versions of the same web page are tracked. This user behavior can be used by the website designers to improve their design, layout, and content for better user experiences.

In these existing testing systems, web servers that receive requests from users to access a web page direct traffic to the different versions using caches. The web page version that is delivered to the user is determined by comparing a user identifier to the HTTP header of the page at the web server. A certain percentage of all traffic to the web server receives each version.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

According to an aspect of the invention, a computer-implemented method is disclosed that includes receiving a user request to access a web page; applying an action to the user request to allocate a user associated with the user request to a test group at a proxy server, each test group associated with a different web page version for testing; and delivering a web page version to the user based on the user's assigned test group.

The method may also include applying a rule to the user request to determine whether the user qualifies for the test.

Each test group may be associated with a web site version for testing, and at least one web page in the web site version may be different than at least one web page in a different web site version.

The different page versions may include one or more of pages having different colors, different layouts, different content or delivery method.

The method may also include tracking the user's interaction with the delivered web page version and subsequent behavior on a web site associated with the web page for each user in each test group.

The method may also include tracking the user's interaction with the deliver web page version and subsequent behavior across multiple web sites, at least one of the multiple web sites associated with the web page for each user in each test group.

The method may also include receiving data that recorded the user's interaction with the delivered web page version and subsequent behavior on a web site associated with the web page for each user in each test group.

The method may also include aggregating the recorded user interaction with the delivered web page version for each user in each test group.

The method may also include storing an identifier associated with the test group in a cookie and delivering the cookie with the delivering of the web page version.

The web page version may be delivered with a tracking gif.

The method may also include analyzing the aggregated data to determine a test result.

According to another aspect of the invention, a computer-readable storage media having computer executable instructions stored thereon which cause a computer system to carry out the above method when executed is disclosed.

According to another aspect of the invention, a computer system is disclosed that includes memory; and a processor coupled to the memory, the processor configured to receive a user request to access a web page, apply an action to the user request to allocate a user associated with the user request to a test group, each test group associated with a different web page version for testing, compare the test group to a header of a web page version in a cache to identify the web page version to deliver to the user, and deliver a web page version to the user based on the user's assigned test group.

The processor may be further configured to apply a rule to the user request to determine whether the user qualifies for the test.

The different page versions may include one or more of pages having different colors, different layouts, different content or delivery method.

Each test group may be associated with a web site version for testing, and wherein at least one web page in the web site version may be different than at least one web page in a different web site version.

According to a further aspect of the invention, a computer system is disclosed that includes a web server configured to receive a page request from a user and deliver a web page to the user in response to the page request; and a multivariate testing proxy in communication with the web server and the cache, the multivariate testing proxy configured to assign the user to a test group, each test group associated with a different page version to deliver to the user.

The computer system may include a cache, the cache storing at least two different page versions, each page version associated with a test group.

The computer system may include a site application, the site application configured to provide the requested web page versions to the web server.

The computer system may include a tracking server, the tracking server configured to track the user's interaction with the delivered web page version.

The computer system may include a tracking server, the tracking server configured to receive data that recorded the user's interaction with the delivered web page version.

The computer system may include a plurality of site applications and a plurality of multivariate testing proxies coupled to the plurality of site applications.

According to a further aspect of the invention, a computer-implemented method is disclosed that includes receiving a user request to access a web page; applying a rule to determine whether a user qualifies for a test; allocating the user to a test group for the test if the user qualifies for the test; assigning an identifier to the user associated with the test group; matching the identifier to a page version associated with the test group; and delivering the page version to the user based on the user's assigned test group.

The page version may include a tracking gif.

According to a further aspect of the invention, a computer-readable storage media is disclosed that has computer executable instructions stored thereon which cause a computer system to carry out a method when executed, the method may include applying a rule to determine whether a user qualifies for a test; allocating the user to a test group for the test if the user qualifies for the test; assigning an identifier to the user associated with the test group; and storing the identifier in a cookie.

The page version may include a tracking gif.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a schematic diagram of a network system according to one embodiment of the invention;

FIG. 2 is a block diagram of an exemplary system architecture according to one embodiment of the invention;

FIG. 3 is a detailed block diagram of the rules proxy according to one embodiment of the invention;

FIG. 4 is a flow diagram for a process for delivering targeted content to a user according to one embodiment of the invention;

FIG. 5 is a flow diagram for a detailed process for delivering targeted content to a user according to one embodiment of the invention;

FIG. 6 is a block diagram of an exemplary system architecture for multivariate page testing according to one embodiment of the invention;

FIG. 6A is a block diagram of another exemplary system architecture for multivariate page testing according to one embodiment of the invention;

FIG. 7 is a flow diagram for a process for delivering multiple page versions to users according to one embodiment of the invention;

FIG. 8 is a flow diagram for a process for tracking a user's interaction with one of multiple page versions according to one embodiment of the invention;

FIG. 9 is a block diagram of a tracking system according to one embodiment of the invention; and

FIG. 10 is a block diagram of an exemplary computer system according to one embodiment of the invention.

### DETAILED DESCRIPTION

Embodiments of the invention relate to an architectural stack that includes a multivariate testing proxy between a web server and a HTTP proxy cache. The multivariate testing proxy receives a user request to access a web page from the web server, applies an action to the user request to assign the user to a test group, each test group associated with a different page or site version for testing, and delivers a web page or site version to the user based on the user's assigned test group. The users' interactions with the delivered web page and subsequent behavior is then tracked or recorded and aggregated with all of the other users in their test group and other test groups. The aggregated data can then be analyzed to determine a test result.

The multivariate testing proxy can determine whether a user is assigned to a test group by examining the user's browser's test cookie, and, if not, assign the user to a test group, according to a predetermined allocation of users to test page versions. The multivariate testing proxy is advantageous because it is more flexible than the prior art approach. In addition, the use of cached pages, API's, and the multivariate testing web proxy allows for improved splits and delivery of test pages. The multivariate testing proxy allows for a scalable system because it does not tie directly into other applications but rather can communicate using HTTP. Because the bucketing logic is in the multivariate testing proxy, the bucketing logic is functionally independent of the content and web server. In addition, the multivariate testing proxy allows for testing across multiple sites, can run tests on a percentage of uses (i.e., not just a percentage of traffic), and it can be used with any downstream architecture (i.e., the downstream architecture can be changed without affecting the bucketing logic).

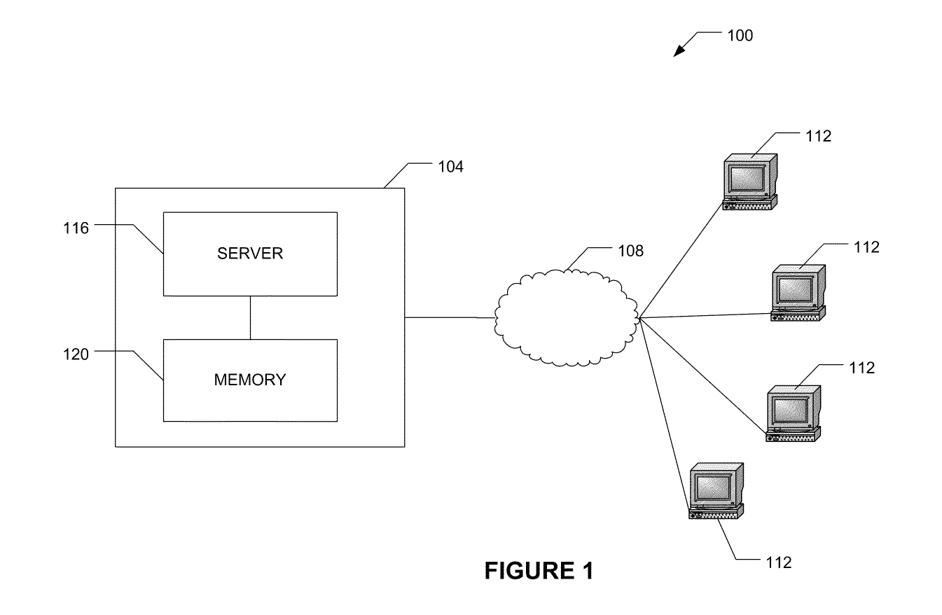

An embodiment of the invention will now be described in detail with reference to FIG. 1. FIG. 1 illustrates a web-based system 100 for delivering content to a user. The system 100 includes a host site 104 and a plurality of user systems 112 coupled via a network 108. The system 104 includes a server 116 and memory 120.

The host site 104 is connected to the plurality of user systems 112 over the network 108. The server 116 is in communication with the memory 120. The system 104 is typically a computer system, and may be an HTTP (Hypertext Transfer Protocol) server (e.g., an Apache server). The memory 120 includes storage media, which may be volatile or non-volatile memory that includes, for example, read only memory (ROM), random access memory (RAM), magnetic disk storage media, optical storage media, flash memory devices and zip drives.

The network 108 is a local area network (LAN), wide area network (WAN), a telephone network, such as the Public Switched Telephone Network (PSTN), an intranet, the Internet, or combinations thereof. The plurality of user systems 112 may be mainframes, minicomputers, personal computers, laptops, personal digital assistants (PDA), cell phones, and the like. The plurality of user systems 112 are characterized in that they are capable of being connected to the network 108. The plurality of user systems 112 typically include web browsers.

When a user of one of the plurality of user systems 112 requests to access the server to view search results responsive to a search query, a request is communicated to the host site 104 over the network 108. For example, a signal is transmitted from one of the user systems 112, the signal having a destination address (e.g., address representing the search results page for the web site), a request (e.g., a request to view the requested page) and a return address (e.g., address representing user system that initiated the request). The request may include a cookie that includes data identifying the user and/or the user computer. The server 116 accesses the memory 120 to provide the user with the requested web page, which is communicated to the user over the network 108. For example, another signal may be transmitted that includes a destination address corresponding to the return address of the client system, and a web page responsive to the request.

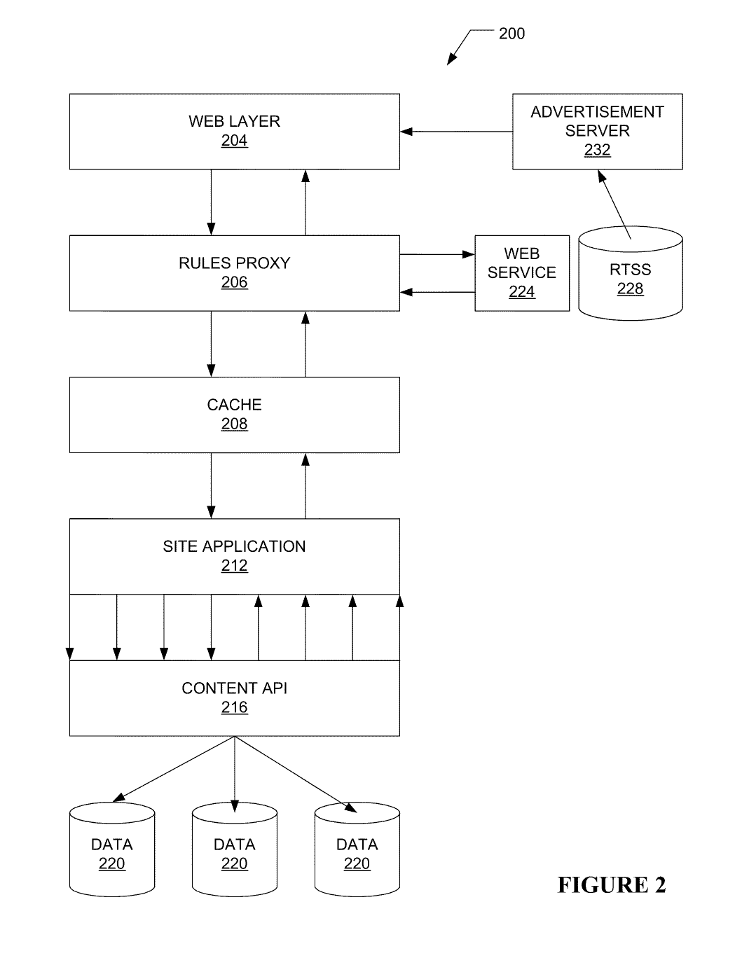

FIG. 2 illustrates an exemplary schematic system architecture 200 at the server 104 according to one embodiment of the invention. It will be appreciated that the system architecture may be implemented as one server (e.g., server 104) or a plurality of servers in communication with one another.

As shown in FIG. 2, the system architecture 200 includes a web layer 204 (or web server), a rules proxy 206, a cache 208, a site application 212, a content API (application programming interface) 216 and a plurality of data stores 220. The rules proxy 206 is in communication with a web service 224 that is coupled to a real-time session store (RTSS) 228. The RTSS 228 is a generic data store that stores user information for a user based on a unique ID. An advertisement server 232 may also be in communication with the web layer 204 and the RTSS 228. It will be appreciated that the system architecture may vary from the illustrated architecture. For example, the web layer 204 may directly access the API 216 which accesses data stores 220, the system architecture 200 may not include the cache 208, the system architecture 200 may include a decoration proxy server, etc., as will be appreciated by those skilled in the art.

The web layer 204 is configured to receive user requests to access content through a web browser and return content that is responsive to the user request. The web layer 204 communicates the user requests to the cache 208. In one embodiment, the web layer 204 is an Apache server.

The cache 208 is configured to temporarily store content that is accessed frequently by the web layer 204 and can be rapidly accessed by the web layer 204. In one embodiment, the cache 208 may be a caching proxy server. The cache 208 communicates the user requests to the site application 212.

The site application 212 is configured to update the cache 208 and to process user requests received from the web layer 204. The site application 212 may identify that the user request is for a page that includes data from multiple sources. The site application 212 can then convert the page request into a request for content from multiple sources and transmits these requests to the site API 216. The site application 212 may also include business logic that determines, for example, how to decorate the web page, the layout of the web page, the components of the web page, and the like.

The content API 216 is configured to simultaneously access data from the plurality of data stores 220 to collect the data responsive to the plurality of requests from the site application 212. The plurality of data stores 220 include data about different sites owned by a company (e.g., download.com, cnet.com, tv.com, etc. owned by CBS Interactive) or are otherwise related.

The data in the data stores 220 is provided to the content API 216, which provides the content to the site application 212. The site application 212 updates the cache 208 and delivers the cached content in combination with the accessed content to the web layer 204, which delivers browsable content to the user.

The rules proxy 206 may be an HTTP proxy server. The rules proxy 206 uses a rules-based approach to determine user session data that should be stored and read and determines how to bucket a user into a user segment. Because the rules proxy 206 is implemented as an HTTP proxy it can sit outside the cache 208, which allows the rules proxy 206 to collect user behavior data for pages that are served from the cache 208. If a user is bucketed in a given user segment, the bucket information is included in the cache key.

When the rules proxy 206 receives an HTTP request, the rules proxy 206 captures referrer data, reads previous session data, runs bucketing rules, proxies requests to the site application server and writes additional session data. For example, the rules proxy 206 may capture referrer data by reading the HTTP “Referer” header to determine whether the user request originated on a third party site. If so and if the site was a search engine, the hostname and search terms are bound to the user's session. The rules proxy 206 may read previous session data by checking for any previously stored session data bound to the user (e.g., from the RTSS 228). It will be appreciated that although the RTSS 228 in FIG. 2 is used to store the user data, any key-based data store may be used to store the user data. If previous session data is found, it is bound to the user.

When the rules proxy 206 runs bucketing rules, the rules proxy 206 looks up the rules configured for the URI path of the request. If any rules are found, the rules are run on the user (i.e., on the user data). The end condition of a successful rule set typically involves conditionally adding a user to one of multiple test groups (also referred to as user buckets). The rules proxy 206 may proxy requests to the site application 212 by adding the bucket information to the HTTP request before proxying the request to the site application 212. The site application 212 can then process the request as it normally would, with the user bucket data at its disposal. This allows the site application 212 to cater the content it serves based on the test group that a user belongs to. In addition, the cache 208 can store the different page versions for each test group.

The rules proxy 206 is also used after the site application 212 handles the request. The rules proxy 206 then runs another set of rules to determine what session data to persist in the session data store (RTSS in this case). It will be appreciated that in one embodiment the request to persist the additional data may be made asynchronously as the tested page is being served to the end user, so as to not have a noticeable impact on page-load time. Exemplary data includes a page, URL, category, site, referring site, referrer search terms and the like.

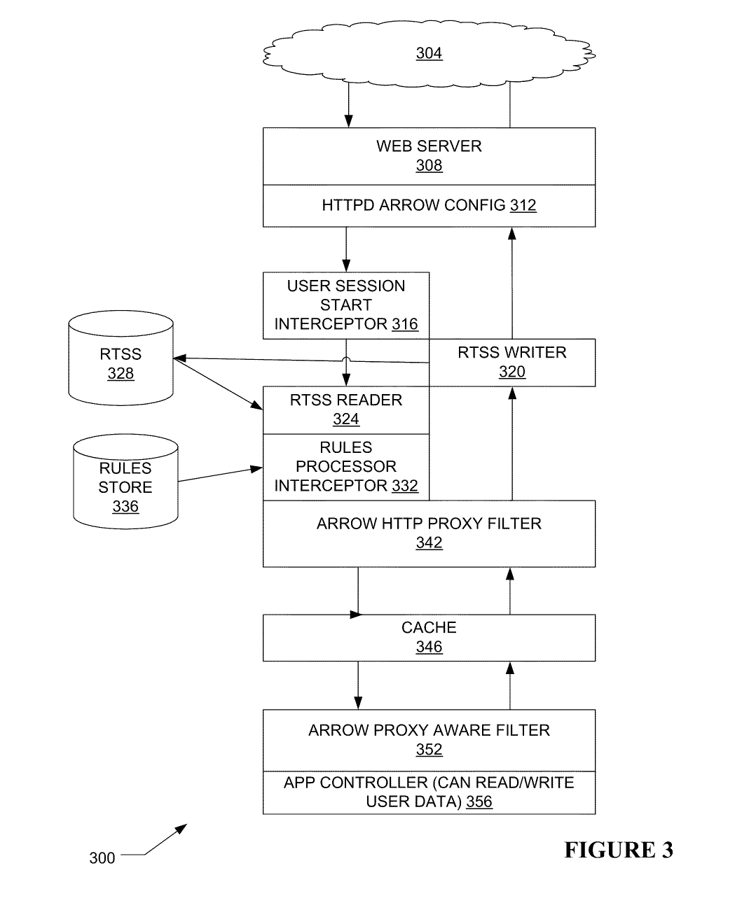

FIG. 3 illustrates a detailed view of an exemplary architecture 300 that includes the rules proxy 206. As shown in FIG. 3, user requests 304 are received at the web server 308, which is communication with the HTTPD arrow config 312. The HTTPD arrow config 312 is in communication with the user session start interceptor 316. An RTSS writer 320 is also in communication with the HTTPD arrow config 312, and the user session start interceptor 316 is in communication with an RTSS reader 324. The RTSS reader 324 reads content from the RTSS 328 and the RTSS writer 320 writes content to the RTSS 328. The RTSS reader 324 is also in communication with the rules processor interceptor 332 which accesses rules in the rules store 336. The rules processor interceptor 332 is in communication with the arrow http proxy filter 342, which is in communication with the cache 346. The cache 346 is in communication with the arrow proxy aware filter 352 which is communication with the app controller 356. The arrow HTTP proxy filter 352 is also in communication with the RTSS writer 320.

As described above, the rules proxy 206 is a webapp that sits outside the outermost HTTP page caching tiers to provide the rules proxy functionality that occurs even when a cached page is returned. In addition to proxying the request to another server tier for handling, the rules proxy serves the following exemplary functions: reading user RTSS data to fetch user information (e.g., past user behavior, etc.), and including this data as an HTTP request header for use by downstream handlers; writing bulk RTSS data to track the browsing activity of our users even when the user is served a cached page; running rules to determine whether a user qualifies for a test; and applying actions to bucket users into test groups. It will be appreciated that most of the functionality provided by the rules proxy can be integrated directly into the page-generating webapp as described below.

HTTPD arrow config 312 (referrer header information) runs on the web server and writes referrer information into headers for use by the rules proxy. The httpd-arrow-config 312 parses the referrer header to extract the external referrer host and search string. This data is set as HTTP headers for downstream applications to consume and as environment values fields for consumption. In one embodiment, the values are only set if the referrer is from a search engine, such as google or yahoo. Exemplary variables include REFERER-HOST and REFERER-SEARCH-TERMS. Exemplary HTTP headers include X-REFERER-HOST and X -REFERER-SEARCH-TERMS.

The user session start interceptor 316 runs on the rules proxy and looks for referrer information in the header and writes it to the user object. The user session start interceptor 316 initializes a few values for the rules proxy system to use. Mainly, the user session start interceptor 316 reacts to the headers set in the httpd-arrow-config config files. The user session start interceptor 316 looks for headers that communicate the following exemplary information via header: the referrer URL, the referrer domain and the referrer search term. If found, this information is stored in the user object and passed on to the next interceptor.

The RTSS reader interceptor 324 runs before the request is proxied downstream. The RTSS reader interceptor 324 reads information from the RTSS 328 that is pertinent to the user and stores it in the user object. The RTSS reader interceptor 324 runs before the request is proxied to the downstream server, and queries the RTSS 328 for any data stored for the current user. The RTSS reader interceptor 324 can be configured to run and get either all or some subset of the user data for each user it encounters. If the RTSS reader interceptor 324 comes across any user data, it stores that data into the user object for later modules to access. Examples of the types of data the RTSS reader interceptor 324 may pull include a user's browsing history, past search terms, user bucket information for multivariate testing, and the like.

The RTSS writer interceptor 320 runs after the request has completed, operates on the user object and stores unsaved data (asynchronously) from the user object to the RTSS 328 before returning the response. The RTSS writer interceptor 320 is an interceptor that runs after the request has completed. The RTSS writer interceptor 320 inspects the user object and looks for values that are marked as needing to be persisted in the RTSS 328 and then asynchronously sends queued RTSS requests to store that data. Examples of the types of data the RTSS reader interceptor 324 stores in the RTSS 328 a user's browsing history, past search terms, user bucket information for multivariate testing, and the like.

The rules processor interceptor 332 can be configured to operate on any object. The rules processor interceptor 332 is a simple rules processing engine that inspects and conditionally mutates an object passed to it. The rules processor interceptor 332 is configured with a collection of rules and conditions which both conform to an interface and are stored in the rules store 336. In one embodiment, the interface has an execute method which results in a positive or negative result. These components can be configured to have positiveNextStep or negativeNextStep methods, each of which also conforms to the component interface. Since actions and conditions both conform to the same interface, the rules processor interceptor 332 can generically nest any combination of conditions and actions. The rules processor interceptor 332 is typically configured to operate on (and modify) an object representing a user.

The Arrow HTTP proxy filter 342 runs before the request is proxied downstream and again after the response returns. Before proxying downstream, the Arrow HTTP proxy filter 342 serializes important information from the user object to headers for reading by the proxy aware filter 352. After receiving the response from the proxy aware filter 352, the Arrow HTTP proxy filter 342 de-serializes header information into the user object so that it may be detected and saved to the RTSS 328 by the RTSS writer 320.

The Arrow HTTP proxy filter 342 is run on the rules proxy server before passing the request on to the downstream server, and receives the response back from the downstream app. Before the Arrow HTTP proxy filter 342 passes the request downstream, the Arrow HTTP proxy filter 342 can inspect the user object to set certain HTTP headers into the request. Exemplary headers include X-USER-RTSS-DATA and X-USER-BUCKET. The X-USER-BUCKET is a token that signifies the additional application state that is not represented in the URL, which can be used by the cache 346 to distinguish different HTML versions of the same page. The arrow proxy aware filter 352 may need to vary based on the X-USER-BUCKET header, which is set by the proxy filter 342. In particular, the arrow proxy filter 342 tells the cache 346 to vary when it responds based on the headers stored in the pages in the cache. After proxying to the downstream app(s), when the Arrow HTTP proxy filter 342 receives a response from downstream, it looks in the response for headers of a specific format. Any headers that match this format are de-serialized and set into the user object, and are persisted in the RTSS 328 by the RTSS writer 320.

The RTSS writer 320 writes common request data to the RTSS 328 for each pageview and can be configured to run for a given set of page types. The RTSS writer 320 may be used to write to the RTSS 328 on an every request basis. For example, a log of a users browsing history may be used by the RTSS writer 320.

The Arrow HTTP proxy aware filter 352 de-serializes header information and stores it in the user object when a request is received and serializes data that has been written into the user object into headers for the rules proxy to persist in the RTSS 328. The Arrow HTTP proxy aware filter 352 is one of the first filters to run on an appserver downstream from the rules proxy, and is also one of the last filters to run on the downstream application server before returning the request to the rules proxy. Before the application processes the request, when the Arrow HTTP proxy aware filter 352 receives a request from the upstream server, the Arrow HTTP proxy aware filter 352 first looks for relevant headers coming from the upstream app, and ingests their data into a user object that can be conveniently used by the controller 356 or JSPs that rely on those headers for their features to work. After the request is processed, the Arrow HTTP proxy aware filter 352 inspects the user object in its request and looks for variables that have been set into the user object and serializes them into response headers that the Arrow HTTP proxy aware filter 352 knows how to read and knows are meant to be stored in the RTSS 328. An exemplary header that can be used to store this information is X-RTSS-PERSIST. The X-RTSS-PERSIST header can contain any number of name value pairs that correlate to values that can be set on the user object. When these are set on the response by the Arrow HTTP proxy aware filter 352, these values will be stored in the RTSS 328.

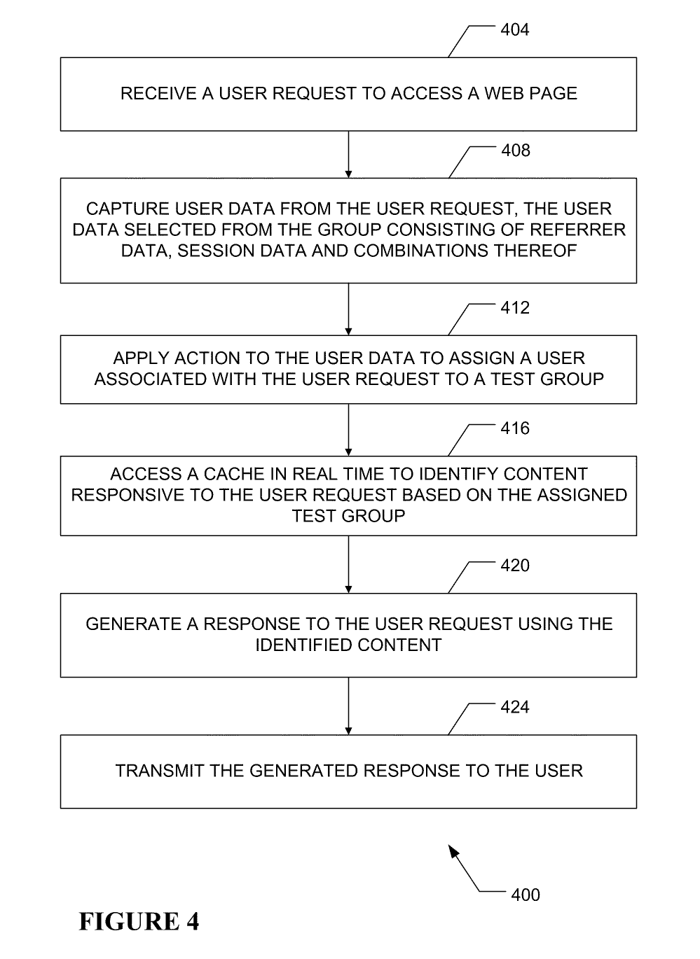

FIG. 4 illustrates a process for collecting data that can be used to target web pages based on the page request 400. It will be appreciated that the process 400 described below is merely exemplary and may include a fewer or greater number of steps, and that the order of at least some of the steps may vary from that described below.

The process 400 begins by receiving a user request to access a web page (block 404). For example, a user may request to access a download.com page.

The process 400 continues by capturing user data from the user request, the user data selected from the group consisting of referrer data, session data and combinations thereof (block 408). Types of data about the user include page, URL, category, site, referrer site and referrer terms.

The process 400 continues by applying an action to the user data to assign a user associated with the user request to a test group (block 412). It will be appreciated that a user may be assigned to multiple test groups. It will also be appreciated that applying the action may include applying one or more rules (i.e., a set of rules) to the user data to determine if the user qualifies for a test and/or allocating users that qualify for a test to a test group.

The process 400 continues by accessing a cache in real time to identify content responsive to the user request based on the assigned test group (block 416). It will be appreciated that the content used to generate a response for the user may be accessed directly from the cache; alternatively, the content may be accessed indirectly from the cache (i.e., from the cache and through the site application, content API and/or data stores).

The process 400 continues by generating a response to the user request using the identified content (block 420). The response includes targeted content based on the user's test group. For example, the web page may include several page components and one or more of the page components may include content selected based on the user's assigned test group. The process 400 continues by transmitting the generated response to the user (block 424).

For example, a user may perform a google search for MacAfee antivirus software. The user may then select a search result that refers the user to the download.com website which provides users with the ability to download antivirus software. The user may be returned a web page that includes advertisements that relate to antivirus software that competes with MacAfee antivirus software. If a user were to download antivirus software, the user is then allocatable for tests associated with downloading antivirus software. The user can then be bucketed into a group for testings. The user could then be targeted with different advertisements related to the website (e.g., an advertisement for tv.com, another website owned by CBS Interactive, or an advertisement for a television show on CBS) to test types of advertisements for users that download antivirus software, delivered content in a different manner to test delivery performance, etc.

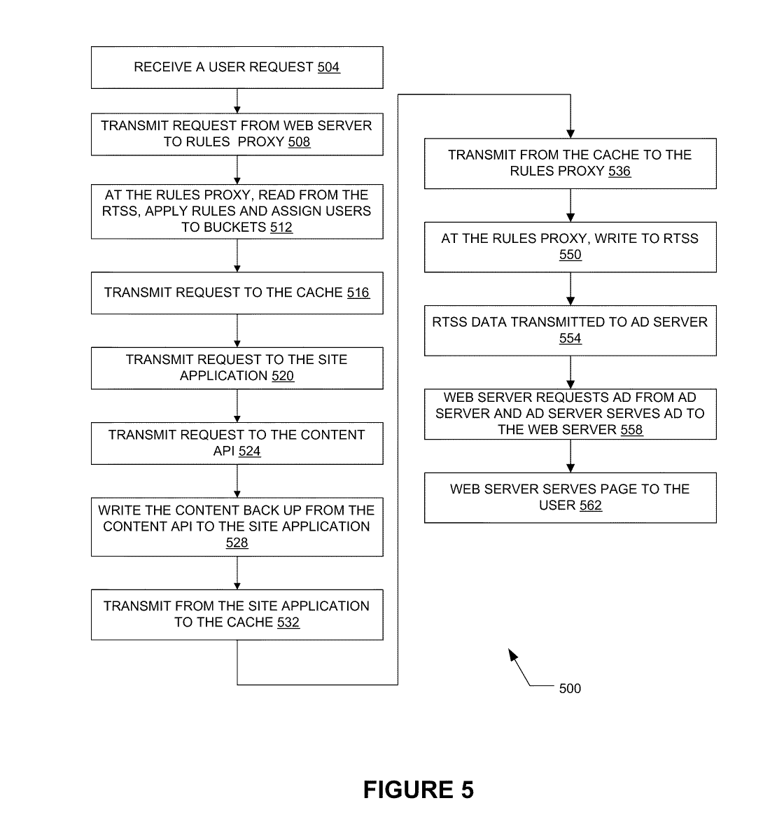

FIG. 5 illustrates a detailed process 500 for delivering a page in response to a page request using the architecture stack illustrated in FIG. 2. It will be appreciated that the process 500 described below is merely exemplary and may include a fewer or greater number of steps, and that the order of at least some of the steps may vary from that described below.

As shown in FIG. 5, the process 500 begins by receiving a user request (block 504). The process 500 continues by transmitting the request from the web server to the rules proxy (block 508). The process 500 continues by, at the rules proxy, reading from the RTSS, applying rules and assigning users to buckets (block 512).

The process 500 continues by transmitting the request to the cache (block 516), transmitting the request to the site application (block 520), and transmitting the request to the content API (block 524).

The process 500 continues by writing the content back up from the content API to the site application (block 528), transmitting the content from the site application to the cache (block 532), and transmitting the content from the cache to the rules proxy (block 536).

The process 500 continues by, at the rules proxy, writing to the RTSS (block 550). The process 500 continues by transmitting RTSS data to the ad server (block 554). The process 500 continues by the web server requesting an ad from the ad server and the ad server serving the ad to the web server (block 558). The process 500 continues by the web server serving a page to the user (block 562).

As described above, embodiments of the invention relate to multivariate testing. In one embodiment, the multivariate testing runs in the rules processor interceptor of the rules proxy. Users are assigned to user buckets, which allocate users into test groups. A page request is manipulated so the HTTP request has the user bucket information that allows different versions of a web page to be displayed to the different user groups. The user's interaction with and reaction to those different pages can then be tracked for testing purposes. Types of testing include, for example, page layout, content, page load and the like.

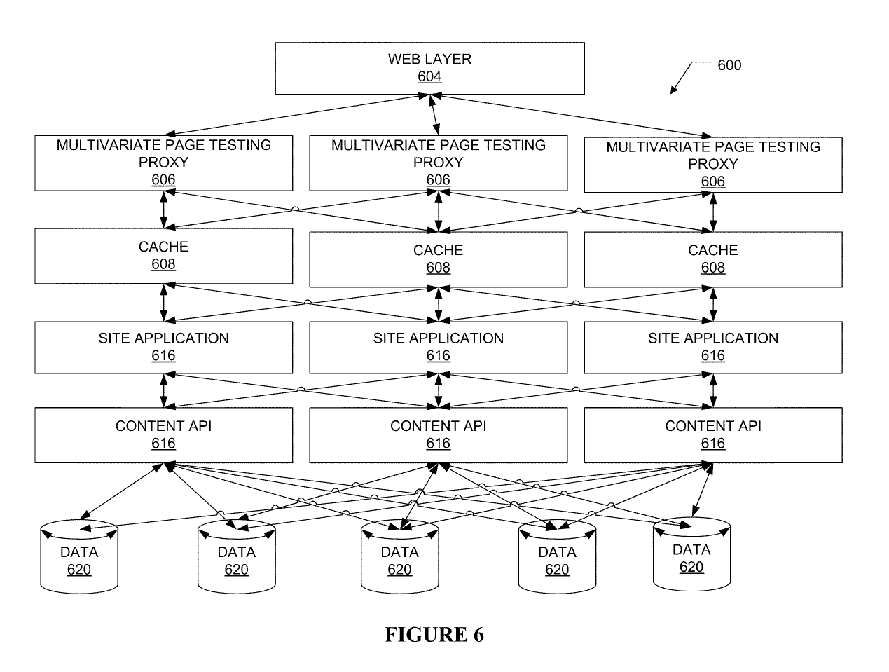

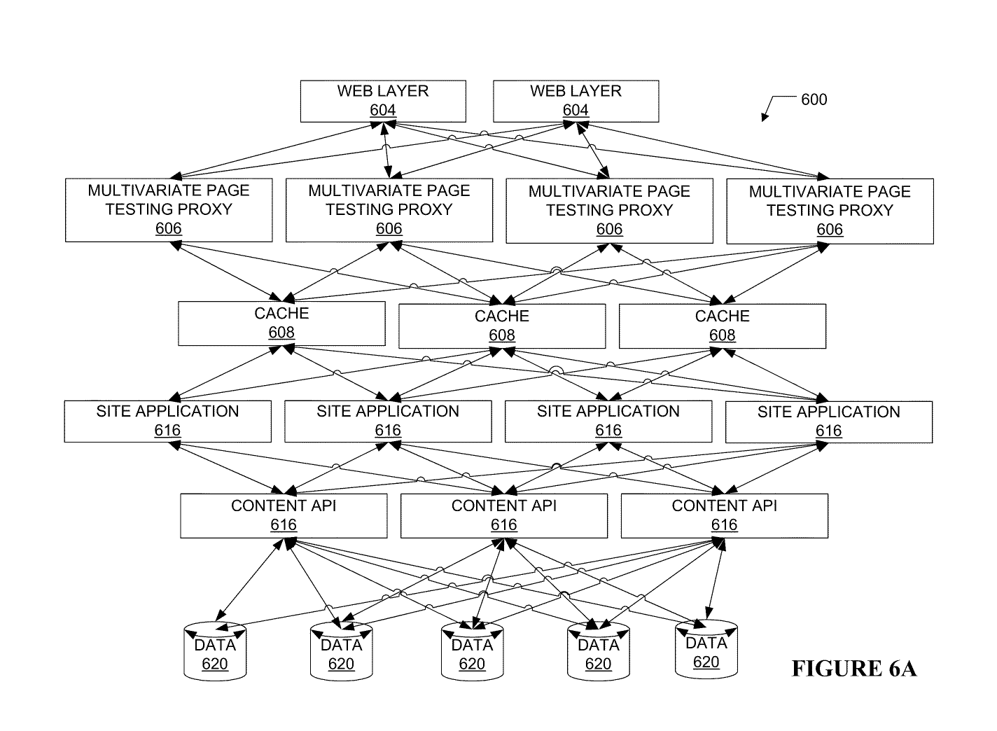

FIG. 6 illustrates a detailed view of an exemplary architecture 600 that includes a multivariate testing proxy 606. As shown in FIG. 6, the architecture includes a web layer 604 (i.e., one or more web servers), one or more multivariate testing proxies 606, one or more caches 608, one or more site applications 612, and one or more content APIs 616 that are in communication with multiple one or more data stores 620.

In FIG. 6, the architecture 600 includes the same number of multivariate testing proxies 606, caches 608 and site applications 612; it will be appreciated, however, that a one-to-one relationship is not required. For example, the architecture may include 12 web servers, 60 multivariate testing proxies 606, 10 caches 608, and 60 site applications 612. In another example, as shown in FIG. 6A, the architecture 600 may include two web servers 604, four multivariate testing proxies 606, three caches 608, and four site applications 612. It will be appreciated that these numbers will vary depending on the particular website(s), number of users and performance requirements of a web domain. It will also be appreciated that the architecture may include additional components. For example, a load balancer may be provided between each of the tiers (e.g., between content APIs 616 and the data stores 620, etc.).

The multivariate testing proxy 606 is configured to coordinate testing of page versions by assigning users to user segment groups (or user buckets) and retrieve a page version depending on the assigned user bucket. It will be appreciated that the MVT proxy 606 may also identify return users and pre-allocated users using user cookies or other identifying information included in the page request.

In one embodiment, the multivariate testing proxy 606 includes multivariate testing metadata and an experiment manger. The multivariate metadata identifies, for example, when to start testing, when to close testing, the percentage of users assigned to each bucket, and the like. The experiment manager uses rules (e.g., thresholds, conditions, etc.) to assign users to a test group and retrieves the page version from the cache 608 associated with that user's test group. For example, the experiment manager may apply rules to determine if a user is a candidate for a test, and then allocates users to the test using a random allocation algorithm to bucket users. The experiment manager may run tests based on a user's history, users that go to certain pages, users that have been referred to the site from a certain domain, etc.

When users are allocated to a test group, an identifier is assigned to the user and stored in the user cookie. It will be appreciated that once the user is already assigned to a test, when the user returns to the website, the cookie will indicate to the multivariate testing proxy 606 that the user is already assigned to a test group (so the tests are not run on returning users). Exemplary cookie formats include: MVT: name: version: group. If the test has two groups, the cookie format for users assigned to each group may be: MVT: sampletest: 1: 101 and MVT: sampletest: 1: 102. Users may be excluded from a test. For example, a user that is excluded from a test may have an exclude cookie: sampletest=exclude. This cookie would inform the multivariate testing proxy that rules for this particular test (e.g., the sample test) should not be applied to this user.

The cache 608 includes content from the site application 612, content API 616 and databases 620 as described above with reference to FIGS. 2-5. The web page stored in the cache 608 may include a HTTP header that includes an identifier corresponding to the user bucket.

The web server 604 delivers the appropriate page to a user's browser, which may include a tracking gif. The HTTP header of the page that is delivered to the user is also embedded with a user identifier (e.g., the cookie or other user identifier). The web server can expand the tracking gif and fill it out with tracking information (e.g., URL, referrer URL, user ID, user browser, etc.). This information is provided to the browser which records the tracking data in the data warehousing application when the browser requests the tracking gif. The aggregated data can be analyzed to generate testing reports that indicate user's responses to the different page versions. It will be appreciated that tracking resources, other than tracking gifs, may be used to track the user's behavior, as known to those skilled in the art.

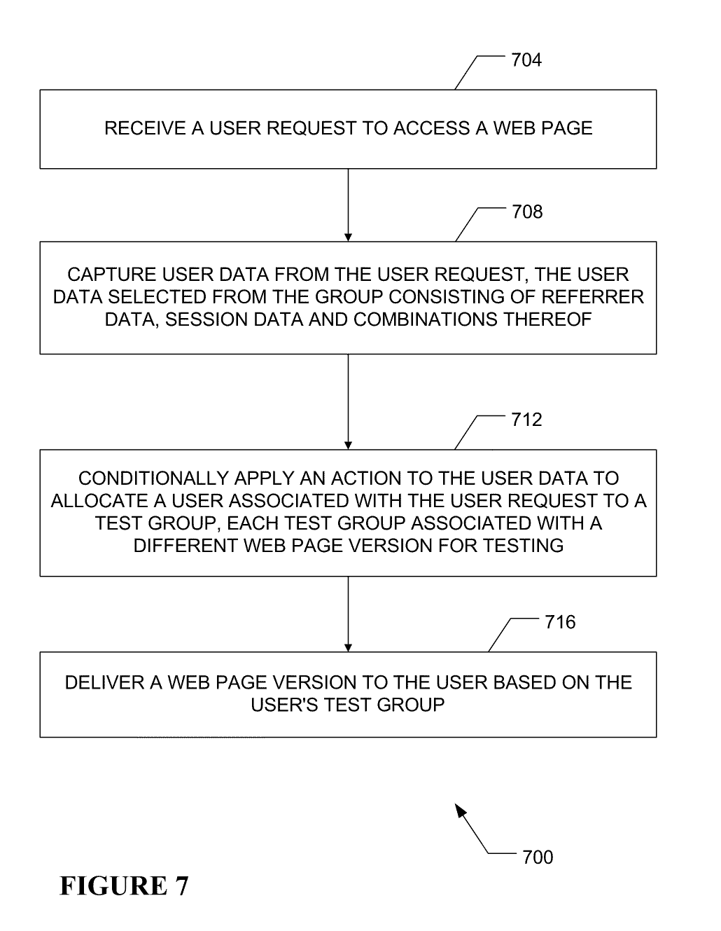

FIG. 7 illustrates an exemplary process 700 for assigning a user an identifier. It will be appreciated that the process 700 described below is merely exemplary and may include a fewer or greater number of steps, and that the order of at least some of the steps may vary from that described below.

As shown in FIG. 7, the process 700 begins by receiving a user request to access a web page (block 704). The process 700 continues by, optionally, capturing user data from the user request (block 708).

The process 700 continues by conditionally applying an action to the user request to assign a user associated with the user request to a test group, each test group associated with a different web page version for testing (block 712).

The process 700 continues by delivering a web page version to the user based on the user's assigned test group (block 716). The process 700 may then continue by tracking the user's interaction with the web page version and aggregating the tracking information from each of the users. The process 700 may then continue by analyzing the aggregated data and generating testing reports.

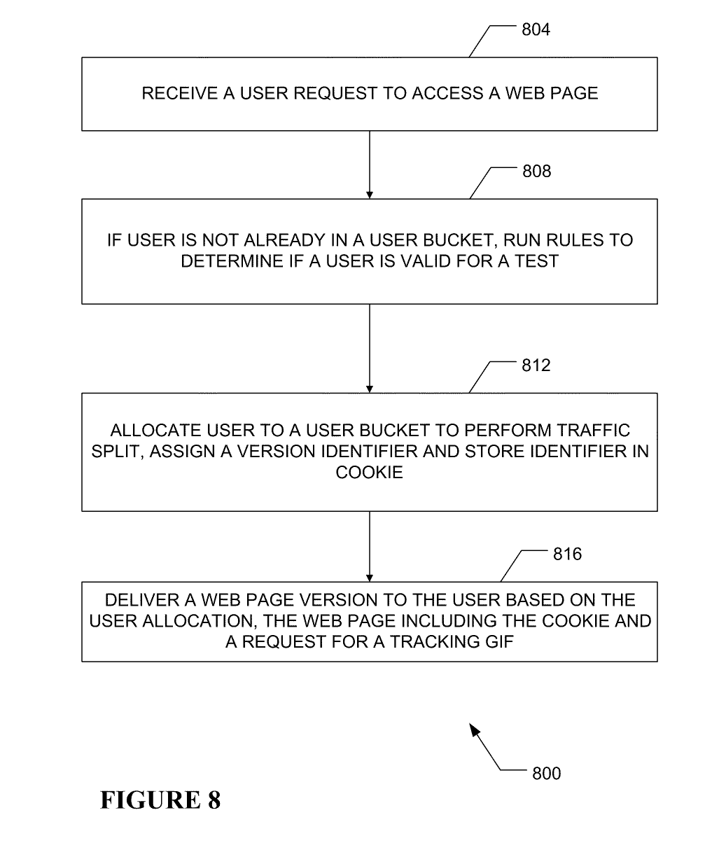

FIG. 8 illustrates an exemplary process 800 for tracking a user's interacton with a website. It will be appreciated that the process 800 described below is merely exemplary and may include a fewer or greater number of steps, and that the order of at least some of the steps may vary from that described below.

As shown in FIG. 8, the process 800 begins by receiving a user request to access a web page (block 804). The process 800 continues by running rules to determine whether to add a user to a test group, if the user is not already in a test group (block 808).

The process 800 continues by allocating the user to a test group to perform a traffic split, assign a user identifier based on the assigned test group and storing the identifier in a cookie (block 812).

The process 800 continues by delivering a web page version to the user based on the allocation, the web page including the cookie and a request for a tracking gif (block 816). The process 800 then continues at the user computer. The user computer requests the tracking gif from a tracking server, which stores a user identifier and the user's interaction with the web page version. The tracking server or an analysis server then aggregates and analyzes the user information and can generate testing reports.

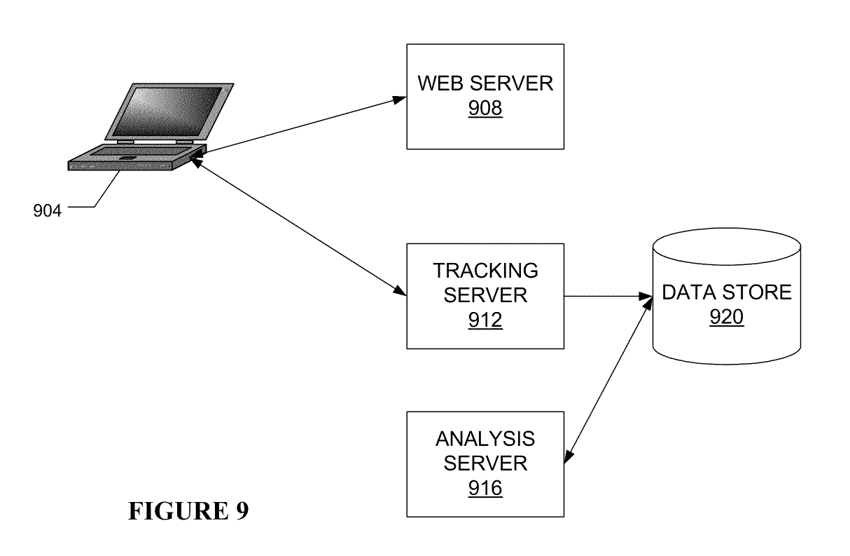

FIG. 9 illustrates an exemplary system for tracking a user's interaction with a website. The browser at the laptop 904 requests a web page from the web server 904.

The web server 904 then delivers a web page to the browser 904. When the browser loads the page it requests the tracking gif from the tracking server 912, which stores the request for the tracking gif in the data store 920. The browser sends the user interactions to the tracking server 912 and stores the user interactions in the data store 920. An analysis server 912 may be coupled to the data store 920 to run reports on the tracked data.

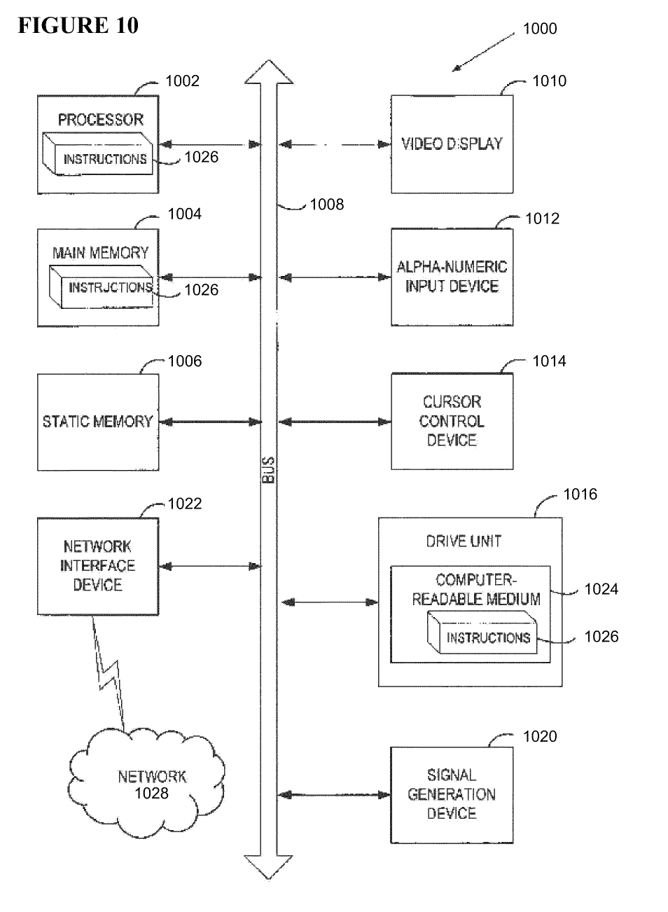

FIG. 10 shows a diagrammatic representation of machine in the exemplary form of a computer system 1000 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1000 includes a processor 1002 (e.g., a central processing unit (CPU), a graphics processing unit (GPU) or both), a main memory 1004 (e.g., read only memory (ROM), flash memory, dynamic random access memory (DRAM) such as synchronous DRAM (SDRAM) or Rambus DRAM (RDRAM), etc.) and a static memory 1006 (e.g., flash memory, static random access memory (SRAM), etc.), which communicate with each other via a bus 1008.

The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a disk drive unit 1016, a signal generation device 1020 (e.g., a speaker) and a network interface device 1022.

The disk drive unit 1016 includes a computer-readable medium 1024 on which is stored one or more sets of instructions (e.g., software 1026) embodying any one or more of the methodologies or functions described herein. The software 1026 may also reside, completely or at least partially, within the main memory 1004 and/or within the processor 1002 during execution thereof by the computer system 1000, the main memory 1004 and the processor 1002 also constituting computer-readable media. The software 1026 may further be transmitted or received over a network 1028 via the network interface device 1022.

While the computer-readable medium 1024 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, and optical and magnetic media.

It should be noted that the server is illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. The computer devices can be PCs, handsets, servers, PDAs or any other device or combination of devices which can carry out the disclosed functions in response to computer readable instructions recorded on media. The phrase “computer system”, as used herein, therefore refers to any such device or combination of such devices.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A computer-implemented method comprising:
receiving a user request to access a web page;
applying an action to the user request to allocate a user associated with the user request to a test group at a proxy server, each test group associated with a different web page version for testing; and
delivering a web page version to the user based on the user's assigned test group.

2. The method of claim 1, further comprising applying a rule to the user request to determine whether the user qualifies for the test.

3. The method of claim 1, wherein each test group is associated with a web site version for testing, and wherein at least one web page in the web site version is different than at least one web page in a different web site version.

4. The method of claim 1, wherein the different page versions include one or more of pages having different colors, different layouts, different content or delivery method.

5. The method of claim 1, further comprising tracking the user's interaction with the delivered web page version and subsequent behavior on a web site associated with the web page for each user in each test group.

6. The method of claim 5, further comprising tracking the user's interaction with the deliver web page version and subsequent behavior across multiple web sites, at least one of the multiple web sites associated with the web page for each user in each test group.

7. The method of claim 1, further comprising receiving data that recorded the user's interaction with the delivered web page version and subsequent behavior on a web site associated with the web page for each user in each test group.

8. The method of claim 7, further comprising aggregating the recorded user interaction with the delivered web page version for each user in each test group.

9. The method of claim 1, further comprising storing an identifier associated with the test group in a cookie and delivering the cookie with the delivering of the web page version.

10. The method of claim 1, wherein the web page version is delivered with a tracking gif.

11. The method of claim 8, further comprising analyzing the aggregated data to determine a test result.

12. A computer-readable storage media having computer executable instructions stored thereon which cause a computer system to carry out a method when executed, the method comprising:
receiving a user request to access a web page;
applying an action to the user request to allocate a user associated with the user request to a test group, each test group associated with a different web page version for testing;
comparing the test group to a header of a web page version in a cache to identify the web page version to deliver to the user; and
delivering a web page version to the user based on the user's assigned test group.

13. The computer-readable storage media of claim 12, further comprising applying a rule to the user request to determine whether the user qualifies for the test.

14. The computer-readable storage media of claim 12, wherein the different page versions include one or more of pages having different colors, different layouts, different content or delivery method.

15. The computer-readable storage media of claim 12, wherein each test group is associated with a web site version for testing, and wherein at least one web page in the web site version is different than at least one web page in a different web site version.

16. A computer system comprising:
memory; and
a processor coupled to the memory, the processor configured to receive a user request to access a web page, apply an action to the user request to allocate a user associated with the user request to a test group, each test group associated with a different web page version for testing, compare the test group to a header of a web page version in a cache to identify the web page version to deliver to the user, and deliver a web page version to the user based on the user's assigned test group.

17. The computer system of claim 16, wherein the processor is further configured to apply a rule to the user request to determine whether the user qualifies for the test.

18. The computer system of claim 16, wherein the different page versions include one or more of pages having different colors, different layouts, different content or delivery method.

19. The computer system of claim 16, wherein each test group is associated with a web site version for testing, and wherein at least one web page in the web site version is different than at least one web page in a different web site version.

20. A computer system comprising:
a web server configured to receive a page request from a user and deliver a web page to the user in response to the page request; and
a multivariate testing proxy in communication with the web server and the cache, the multivariate testing proxy configured to assign the user to a test group, each test group associated with a different page version to deliver to the user.

21. The computer system of claim 20, further comprising a cache, the cache storing at least two different page versions, each page version associated with a test group.

22. The computer system of claim 20, further comprising a site application, the site application configured to provide the requested web page versions to the web server.

23. The computer system of claim 20, further comprising a tracking server, the tracking server configured to track the user's interaction with the delivered web page version.

24. The computer system of claim 20, further comprising a tracking server, the tracking server configured to receive data that recorded the user's interaction with the delivered web page version.

25. The computer system of claim 20, further comprising a plurality of site applications and a plurality of multivariate testing proxies coupled to the plurality of site applications.

26. A computer-implemented method comprising:
receiving a user request to access a web page;
applying a rule to determine whether a user qualifies for a test;
allocating the user to a test group for the test if the user qualifies for the test;
assigning an identifier to the user associated with the test group;
matching the identifier to a page version associated with the test group; and
delivering the page version to the user based on the user's assigned test group.

27. The method of claim 26, wherein the page version comprises a tracking gif.

28. A computer-readable storage media having computer executable instructions stored thereon which cause a computer system to carry out a method when executed, the method comprising:
applying a rule to determine whether a user qualifies for a test;
allocating the user to a test group for the test if the user qualifies for the test;
assigning an identifier to the user associated with the test group; and
storing the identifier in a cookie.

29. The computer readable storage medium of claim 28, wherein the page version comprises a tracking gif.
